(19) United States
(12) Patent Application Publication
(10) Pub. No.: US 2010/0060621 A1
(43) Pub. Date: Mar. 11, 2010

(54) SOURCE DRIVER DEVICE AND DISPLAY DEVICE HAVING THE SAME

(75) Inventor: Chuan-Chien Hsu, Tainan (TW)

Correspondence Address: BAKER & MCKENZIE LLP;PATENT DEPARTMENT, 2001 ROSS AVENUE, SUITE 2300, DALLAS, TX, 75201, US

(73) Assignee: HIMAX TECHNOLOGIES LIMITED, Tainan (TW)

(21) Appl. No.: 12/208,033

(22) Filed: Sep. 10, 2008

(51) Int. Cl. G09G 5/00; G09G 3/36

(52) U.S. Cl. 345/211; 345/87

(57) ABSTRACT

A source driver device for driving a display panel includes a gamma voltage generator having a storage element and a plurality of gamma digital-to-analog converters, a data digital-to-analog converter coupled to the gamma voltage generator, and a receiver for receiving input display data from a data bus, for parsing the input display data to transmit generated display data to the data digital-to-analog converter, and for transmitting a plurality of gamma data signals to the storage element, wherein each of the plurality of gamma digital-to-analog converters receive the plurality of gamma data signals from the storage element for generating a plurality of reference voltage signals based on the corresponding gamma data signals, and wherein the data digital-to-analog converter is coupled to the receiver to receive the generated display data, according to the generated plurality of reference voltage signals generated from the gamma digital-to-analog converters, and to generate a driving voltage signal based on the generated display data for driving the display panel.

### BACKGROUND

1. Technical Field

The embodiments described herein relate to a driving device and, more particularly, to a source driver and a display device having the same.

2. Related Art

In general, liquid crystal display (LCD) devices are enabled to display images, wherein digital data signals of the images are converted into analog data signals to control liquid crystal material of a liquid crystal display panel. In addition, during the digital-to-analog conversion process, several different gamma reference voltages are required as input to a digital-to-analog converter (DAC).

Conventional LCD devices commonly include a gate driving circuit, a source driving circuit, and a gamma reference voltage generator. The liquid crystal display panel includes a plurality of gate lines arranged at fixed intervals along a first direction, and a plurality of data lines arranged at fixed intervals along a second direction orthogonal to the gate lines, thereby forming a pixel region in a matrix array at each crossing of the gate and data lines.

The gate driving circuit sequentially accessed the gate lines to activate the corresponding pixels of the liquid crystal display panel. The source driving circuit converts externally input red (R), green (G), and blue (B) digital video data signals into analog data signals, and outputs the converted analog video data signals to each of the plurality of data lines for activation of pixels within the pixel region. This is commonly referred to as a scanning process. In order to convert the R, G, and B digital video data signals into analog data signals, a digital-to-analog conversion is performed using reference voltages output from the gamma reference voltage generator, thereby generating liquid crystal driving voltages. The generated liquid crystal driving voltages are applied to the plurality of data lines of the liquid crystal display panel during each scan of the scanning process.

The gamma reference voltage generator includes a plurality of resistors serially connected between a first power terminal Vdd and a second power terminal Vss. Accordingly, the plurality of gamma reference voltages is supplied to a source driver IC in order to generate multiple sets of gray level voltages being used for the DAC. Accordingly, several operational amplifier (OP-AMP) integrated circuits (IC) are required to be additionally arranged within the LCD device in order to avoid voltage drops in the reference voltage caused by the loading effect. As a result, driving of the liquid crystal display panel is corrupted. Moreover, in order to generate multiple sets of gamma reference voltages generally requires a corresponding number of resistors and OP-AMPs to be incorporated into the LCD device, usually on a printed circuit board (PCB) of the LCD device.

Since conventional gamma voltage generating devices require the additional resistors and OP-AMPs on the PCB, the costs for fabrication of LCD devices increases. Moreover, the increase in required space on the PCB prevents reduction of the LCD device.

### SUMMARY

A source driving device and a display device having a source driver device are described herein.

In one aspect, a source driver device for driving a display panel includes a gamma voltage generator having a storage element and a plurality of gamma digital-to-analog converters, a data digital-to-analog converter coupled to the gamma voltage generator, and a receiver for receiving input display data from a data bus, for parsing the input display data to transmit generated display data to the data digital-to-analog converter, and for transmitting a plurality of gamma data signals to the storage element, wherein each of the plurality of gamma digital-to-analog converters receive the plurality of gamma data signals from the storage element for generating a plurality of reference voltage signals based on the corresponding gamma data signals, and wherein the data digital-to-analog converter is coupled to the receiver to receive the generated display data, according to the generated plurality of reference voltage signals generated from the gamma digital-to-analog converters, and to generate a driving voltage signal based on the generated display data for driving the display panel.

In another aspect, a display device includes a display panel, and a source driver having a gamma voltage generator having including a storage element, a plurality of gamma digital-to-analog converters, and a voltage divider, a data digital-to-analog converter coupled to the gamma voltage generator, and a receiver for receiving input display data transmitted along a data bus, for parsing the input display data to transmit generated display data to the data digital-to-analog converter, and for transmitting a plurality of gamma data signals to the storage element, wherein the storage element is coupled to the receiver and receives and stores the plurality of gamma data signals, wherein the plurality of gamma digital-to-analog converters are coupled to the storage element to receive the plurality of gamma data signals for generating a plurality of reference voltage signals based upon the plurality gamma data signals, and wherein the voltage divider is coupled to the gamma digital-to-analog converters for generating a plurality of gamma voltage signals based on the plurality of reference voltage signals, the data digital-to-analog converter is coupled to the receiver to receive the generated display data, and to generate driving voltage signals based on the generated display data for driving the display panel according to the plurality of gamma voltage signals received from the voltage divider.

These and other features, aspects, and embodiments are described below in the section “Detailed Description.”

### BRIEF DESCRIPTION OF THE DRAWINGS

Features, aspects, and embodiments are described in conjunction with the attached drawings, in which:

FIG. 1 is a schematic circuit diagram of an exemplary source driver according to one embodiment; and

FIG. 2 is a schematic circuit diagram of another exemplary source driver according to another embodiment.

### DETAILED DESCRIPTION

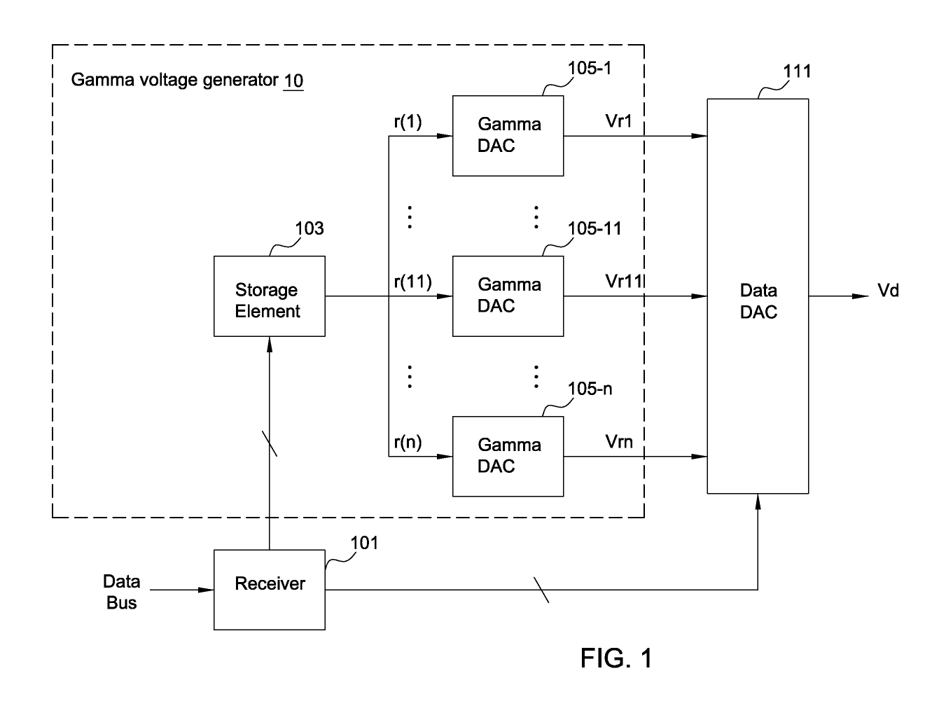

FIG. 1 is a schematic circuit diagram of an exemplary source driver according to one embodiment. In FIG. 1, a source driver for driving a display panel can be configured to include a receiver 101, a gamma voltage generator 10, and a data DAC 111. The gamma voltage generator 10 can include a storage element 103, and a plurality of gamma digital-to-analog converters (DACs) 105-1 to 105-n. The receiver 101 can receive data from a data bus, and can parse the data to transmit display data to the data DAC 111 and transmit gamma data signals ‘r(1)’ to ‘r(n)’ to the storage element 103. The storage element 103 can be coupled to the receiver 101, and can receive and store the gamma data signals ‘r(1)’ to ‘r(n)’. Here, the storage element 103 can include a Static Random Access Memory (SRAM), a dynamic random access memory (DRAM), and a synchronous dynamic random access memory (SDRAM), for example. The plurality of gamma DACs 105-1 to 105-n can be coupled to the storage element 103, and can receive gamma data signals ‘r(1)’ to ‘r(n)’, respectively, for generating reference voltage signals ‘Vr1’ to ‘Vrn’ based on the corresponding received gamma data signals ‘r(1)’ to ‘r(n)’.

Furthermore, the gamma DACs 105-1 to 105-n can be resistive DACs (R-DACs), each including a plurality of resistors, for example. In addition, with regard to the gamma data signals ‘r(1)’ to ‘r(n)’, the number ‘n’ can range from about 6 to about 20, for example.

In FIG. 1, the data DAC 111 can be coupled to the receiver 101 to receive the display data signals from the receiver 101, and can generate driving voltage signals ‘Vd’ based upon the display data signals and the reference voltage signals ‘Vr1’ to ‘Vrn’ for driving a display panel.

It is preferable that the gamma data signals ‘r(1)’ to ‘r(n)’ can be sent to the receiver 101 during a vertical blanking time interval (VBI). Input data provided to the receiver 101 via a data bus can be transmitted via Reduced Swing Differential Signaling (RSDS) to output the gamma data signals ‘r(1)’ to ‘r(n)’ and the display data. The gamma data signals ‘r(1)’ to ‘r(n)’ can be digital signals, such as TTL Transistor-Transistor Logic (TTL) signals, for example, and can be transmitted during the VBI. Alternatively, the gamma data signals ‘r(1)’ to ‘r(n)’ can be sent to the receiver 101 during a horizontal blanking time interval (HBI). Moreover, the gamma data signals ‘r(1)’ to ‘r(n)’ can be sent to the receiver 101 before a start pulse signal is sent to a source driver. The start pulse signal can indicate that the source driver begins to receive display data.

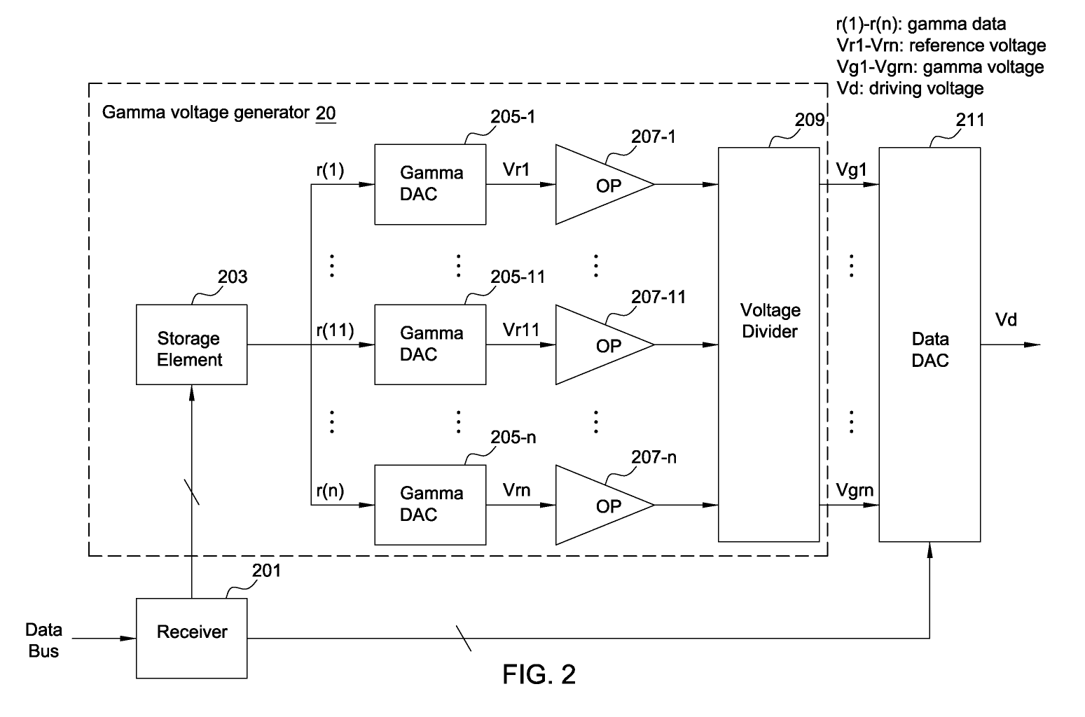

FIG. 2 is a schematic circuit diagram of another exemplary source driver according to another embodiment. In FIG. 2, a display device, such as an LCD device having a gamma source driver, can be configured to include a receiver 201, a gamma voltage generator 20, and a data DAC 211. The gamma voltage generator 20 can include a storage element 203, a plurality of gamma DACs 205-1 to 205-n, a plurality of operational amplifiers 207-1 to 207-n, and a voltage divider 209.

The receiver 201 can receive data signals from a data bus and parse the data signals to transmit display data to the data DAC 211, and can transmit gamma data signals ‘r(1)’ to ‘r(n)’ to the storage element 203. The storage element 203 can be coupled to the receiver 201, and can receive and store the gamma data signal ‘r(1)’ to ‘r(n)’. The gamma DACs 205-1 to 205-n can be coupled to the storage element 203, and can receive the gamma data signals ‘r(1)’ to ‘r(n)’, respectively, for generating reference voltage signals ‘Vr1’ to ‘Vrn’ based on the corresponding gamma data signals ‘r(1)’ to ‘r(n)’.

In FIG. 2, the operational amplifiers 207-1 to 207-n can be coupled between the gamma DACs 205-1 to 205-n and the voltage divider 209 for enhancing the generated reference voltage signals ‘Vr1’ to ‘Vrn’ generated by the gamma DACs 205-1 to 205-n. The operational amplifiers 207-1 to 207-n can buffer the generated reference voltage signals ‘Vr1’ to ‘Vrn’ from the gamma DACs 205-1 to 205-n in order to avoid voltage drops in the reference voltage.

The voltage divider 209 can include, for example, a non-linear DAC coupled to the operational amplifiers 207-1 to 207-n for generating gamma voltages signals ‘Vg1’ to ‘Vgm’ based on the reference voltage signals ‘Vr1’ to ‘Vrn’, wherein “m” is greater than “n”. Additionally, the voltage divider 209 can be configured as a resistor string and can be used for interpolating the reference voltage signals ‘Vr1’ to ‘Vrn’. The data DAC 211 can be coupled to the receiver 201 to receive the display data, and coupled to the voltage divider 209 to receive the generated gamma voltage signals ‘Vg1’ to ‘Vgm’ in order to generate a driving voltage signal ‘Vd’ based on the display data for driving the display panel.

In FIG. 2, the storage element 203 can be coupled to the receiver 201, and can receive and store the gamma data signals ‘r(1)’ to ‘r(n)’. Here, the storage element 203 can include a Static Random Access Memory (SRAM), a dynamic random access memory (DRAM), a synchronous dynamic random access memory (SDRAM), for example.

The plurality of gamma DACs 205-1 to 205-n can be coupled to the storage element 203, and can receive gamma data signals ‘r(1)’ to ‘r(n)’, respectively, for generating reference voltage signals ‘Vr1’ to ‘Vrn’ based on the corresponding received gamma data signals ‘r(1)’ to ‘r(n)’. Furthermore, the gamma DACs 205-1 to 205-n can be resistive DACs (R-DACs), each including a plurality of resistors, for example. In addition, with regard to the gamma data signals ‘r(1)’ to ‘r(n)’, and the number ‘n’ can range from about 6 to about 20, for example.

In accordance with the above-described embodiments, the gamma source driver can be configured on a semiconductor IC chip, wherein each element of the gamma source driver can be integrally disposed within the IC chip.

In accordance with the above-described embodiments, it is preferable that the gamma data signals are transmitted to the receiver 201 during a VBI. In addition, the input display data input to the receiver 201 can be transmitted via Reduced Swing Differential Signaling (RSDS) signal data, and can be transmitted to the receiver 201 to output gamma data signals and the display data. The gamma data signals can be digital, and can be Transistor-Transistor Logic (TTL) signals and can also be transmitted during the VBI.

While certain embodiments have been described above, it will be understood that the embodiments described are by way of example only. Accordingly, the device and method described herein should not be limited based on the described embodiments. Rather, the devices and methods described herein should only be limited in light of the claims that follow when taken in conjunction with the above description and accompanying drawings.

What is claimed is:

1. A source driver device for driving a display panel, the source driver device comprising:
a gamma voltage generator having a storage element and a plurality of gamma digital-to-analog converters;
a data digital-to-analog converter coupled to the gamma voltage generator; and
a receiver for receiving input display data from a data bus, for parsing the input display data to transmit generated display data to the data digital-to-analog converter, and for transmitting a plurality of gamma data signals to the storage element,
wherein each of the plurality of gamma digital-to-analog converters receive the plurality of gamma data signals from the storage element for generating a plurality of reference voltage signals based on the corresponding gamma data signals, and
wherein the data digital-to-analog converter is coupled to the receiver to receive the generated display data, according to the generated plurality of reference voltage signals generated from the gamma digital-to-analog converters, and to generate a driving voltage signal based on the generated display data for driving the display panel.

2. The source driver device of claim 1, further comprising a plurality of operational amplifiers, each coupled one of the plurality of gamma digital-to-analog converters, for enhancing the plurality of reference voltage signals.

3. The source driver device of claim 1, further comprising a voltage divider coupled to the plurality of gamma digital-to-analog converters for interpolating the reference voltage signals.

4. The source driver device of claim 3, wherein the voltage divider includes a resistor string.

5. The source driver device of claim 1, wherein the plurality of gamma digital-to-analog converters include a resistive digital-to-analog converter that includes a plurality of resistors.

6. The source driver device of claim 1, wherein the display panel includes liquid crystal display.

7. The source driver device of claim 1, wherein the storage element includes one of a Static Random Access Memory device, a Dynamic Random Access Memory device, and a Synchronous Dynamic Random Access Memory device.

8. The source driver device of claim 1, wherein the plurality of gamma data signals is transmitted to the receive during a vertical blanking time interval.

9. The source driver device of claim 1, wherein the plurality of gamma data signals is transmitted to the receiver during a horizontal blanking time interval.

10. The source driver device of claim 1, wherein the plurality of gamma data signals is transmitted before a start pulse is supplied to the source driver device.

11. The source driver device of claim 1, wherein the input display data includes Reduced Swing Differential Signaling signals.

12. The source driver device of claim 1, wherein the plurality of gamma data signals includes Transistor-Transistor Logic signals.

13. A display device, comprising:
a display panel; and
a source driver including:
a gamma voltage generator having including a storage element, a plurality of gamma digital-to-analog converters, and a voltage divider;
a data digital-to-analog converter coupled to the gamma voltage generator; and
a receiver for receiving input display data transmitted along a data bus, for parsing the input display data to transmit generated display data to the data digital-to-analog converter, and for transmitting a plurality of gamma data signals to the storage element,
wherein the storage element is coupled to the receiver and receives and stores the plurality of gamma data signals,
wherein the plurality of gamma digital-to-analog converters are coupled to the storage element to receive the plurality of gamma data signals for generating a plurality of reference voltage signals based upon the plurality gamma data signals, and
wherein the voltage divider is coupled to the gamma digital-to-analog converters for generating a plurality of gamma voltage signals based on the plurality of reference voltage signals, the data digital-to-analog converter is coupled to the receiver to receive the generated display data, and to generate driving voltage signals based on the generated display data for driving the display panel according to the plurality of gamma voltage signals received from the voltage divider.

14. The display device of claim 13, wherein the display device is a liquid crystal display device.

15. The display device of claim 13, wherein the input display data include Reduced Swing Differential Signaling signals, and the plurality of gamma data signals include Transistor-Transistor Logic signals.

16. The display device of claim 13, wherein the source driver is a semiconductor integrated circuit chip, and the gamma voltage generator, the storage element, the plurality of gamma digital-to-analog converters, the voltage divider, the data digital-to-analog converter, and the receiver are integral on the semiconductor integrated circuit chip.

17. The display device of claim 13, wherein the storage element includes one of a Static Random Access Memory device, a Dynamic Random Access Memory device, and a Synchronous Dynamic Random Access Memory device.

18. The display device of claim 13, wherein the source driver further comprises a plurality of operational amplifiers connected between the plurality of gamma digital-to-analog converters and the voltage divider.

19. The display device of claim 13, wherein the plurality of gamma data signals is transmitted to the receiver during a vertical blanking time interval.

20. The display device of claim 13, wherein the plurality of gamma data signals is transmitted to the receiver during a horizontal blanking time interval.

21. The display device of claim 13, wherein the plurality of gamma data signals is transmitted before a start pulse is supplied to the source driver device.
